(19) United States
(12) Patent Application Publication
(10) Pub. No.: US 2021/0387305 A1
(43) Pub. Date: Dec. 16, 2021

(54) PROCESSING MACHINE AND METHOD FOR TRACK PROCESSING

(71) Applicant: ROBEL BAHNBAUMASCHINEN GMBH, Freilassing (DE)

(72) Inventor: Thomas Hoelzlwimmer, Burgkirchen (DE)

(21) Appl. No.: 17/348,966

(22) Filed: Jun. 16, 2021

(30) Foreign Application Priority Data
Jun. 16, 2020 (DE) 10 2020 207 441.0

(51) Int. Cl. B24B 19/00

(52) U.S. Cl. CPC B24B 19/004

(57) ABSTRACT

A processing machine for track processing includes a carrier which is connected to a chassis through a joint unit. A processing assembly and an energy supply unit are disposed at the carrier. The energy supply unit acts as a counterweight in a working state of the processing machine. The processing machine includes an adjustment mechanism for adjusting a distance between a center of gravity of the processing assembly and a center of gravity of the counterweight. A method for track processing is also provided. This enables simple, operator-friendly and flexible track processing.

### CROSS-REFERENCE TO RELATED APPLICATION

This application claims the priority, under 35 U.S.C. § 119, of German Patent Application DE 10 2020 207 441.0, filed Jun. 16, 2020; the prior application is herewith incorporated by reference in its entirety.

### BACKGROUND OF THE INVENTION

### Field of the Invention

The invention relates to a processing machine and a method for track processing.

A manually slidable machine for track processing and track maintenance is known from German Utility Model DE 20 2012 007 818 U1. The machine includes a chassis frame at which a working unit and a motor unit are disposed. The machine is used, for example, for mounting rail clamps. The working unit includes a drivable working tool. The motor unit serves to supply energy to the working unit and is connected to it by a detachable coupling. The working unit and the motor unit can be separated from each other for transport, which reduces the physical workload of an operator.

A processing machine for track processing is known from French Patent Application FR 982 711 A. The processing machine includes a carrier which is connected to a chassis through a joint unit. The carrier is configured rigidly. A tool and a motor are attached to the carrier. The motor serves as a counterweight to the tool.

### BRIEF SUMMARY OF THE INVENTION

It is accordingly an object of the invention to provide a processing machine and a method for track processing, which overcome the hereinafore-mentioned disadvantages of the heretofore-known machines and methods of this general type and which provide a manually displaceable processing machine that enables simple, operator-friendly and flexible track processing.

With the foregoing and other objects in view there is provided, in accordance with the invention, a processing machine for track processing, comprising a carrier, a chassis disposed on the carrier for manually sliding the processing machine on a rail of a track, a joint unit for swiveling the carrier relative to the chassis, a processing assembly disposed on the carrier for processing the track, a counterweight to the processing assembly disposed at the carrier, and an adjustment mechanism for adjusting a distance between a center of gravity of the processing assembly and a center of gravity of the counterweight.

The adjustment mechanism allows for adjusting the distance between the center of gravity of the processing assembly and the center of gravity of the counterweight. This enables an overall center of gravity of the processing machine to be positioned substantially above the joint unit so that the processing machine is balanced relative to the joint unit. The balancing avoids unwanted tilting moments during the processing of the track, allowing for easy and operator-friendly track processing. Different weights of the processing assembly, for example due to different processing tools and/or different drive motors, can be balanced in a simple manner by the adjustment mechanism. By adjusting the distance, an overall center of gravity of the processing machine relative to the joint unit, in particular relative to a vertical plane, is positioned. The vertical plane is in particular defined by a horizontal swivel axis of the joint unit and runs perpendicularly to a horizontal plane. The horizontal plane is in particular defined by the axes of rotation of the chassis. The overall center of gravity can be positioned in a working state in the vertical plane and in a transport state outside the vertical plane by the adjustment mechanism. The adjustment mechanism in particular allows for continuous adjustment of the distance between the center of gravity of the processing assembly and the center of gravity of the counterweight. The distance is adjustable in particular in parallel with a plane defined by the chassis. The adjustment mechanism preferably allows the distance to be adjusted manually. Preferably, the adjustment mechanism allows the processing assembly and the counterweight to be displaced relative to each other. In addition, the adjustment mechanism enables the processing machine to be transferred from a compact transport state to a balanced working state and vice versa. The adjustment mechanism is in particular at least partially integrated into the carrier. The carrier encompasses the adjustment mechanism in particular at least partially.

The processing machine is in particular manually displaceable on a track, for example movable or slidable, and/or manually actuatable. Preferably, the processing assembly can be swiveled manually by using the joint unit. The processing unit is configured, for example, as a screwing machine for mounting or tightening and/or for dismounting or loosening sleeper screws and/or as a clipping machine for mounting and dismounting rail clamps. The processing assembly includes in particular an electric drive motor for driving a processing tool. Preferably, the processing machine includes a control unit for controlling the processing assembly.

A processing machine, in which the joint unit has a horizontal swivel axis for the height adjustment of the processing assembly, ensures a simple, operator-friendly and flexible track processing. The horizontal swivel axis enables a manual height adjustment of the processing assembly. Due to this, for example, a processing tool is guided to the track processing point. For example, a sleeper screw is tightened and/or loosened and/or a rail clamp is mounted and/or dismounted. The horizontal swivel axis defines a vertical plane. The vertical plane is in particular perpendicular to a plane defined by the chassis. The center of gravity of the processing assembly and the center of gravity of the counterweight are disposed on different sides of the vertical plane in a working state. In particular, the processing assembly and the counterweight are disposed on different sides of the vertical plane in the working state. Preferably, the adjustment mechanism serves to arrange an overall center of gravity of the processing machine close to the vertical plane, in particular in the vertical plane.

A processing machine, in which the joint unit has a vertical swivel axis for positioning the processing assembly on two sides of a rail, ensures a simple, operator-friendly and flexible track processing. The vertical swivel axis enables a processing tool to be positioned on two sides of a rail by simple manual swiveling. This allows, for example, sleeper screws and/or rail clamps to be mounted/dismounted on the two sides of a rail. The vertical swivel axis runs in particular perpendicularly to a horizontal swivel axis of the joint unit. Preferably, the vertical swivel axis is perpendicular to a plane defined by the chassis.

A processing machine, in which the processing assembly and the counterweight are disposed on different sides of a plane which is defined by the joint unit, ensures a simple, operator-friendly and flexible track processing. The joint unit, in particular a horizontal swivel axis and/or a vertical swivel axis, defines a vertical plane. The vertical plane is in particular perpendicular to a horizontal plane defined by the chassis. Due to the fact that the processing assembly and the counterweight are disposed on different sides of the vertical plane in a working state, an overall center of gravity of the processing machine can be positioned close to the vertical plane, in particular in the vertical plane, by using the adjustment mechanism. As a result, the processing machine is balanced relative to the joint unit, in particular relative to the horizontal swivel axis. In particular, the adjustment mechanism allows the counterweight to be displaced relative to the vertical plane.

A processing machine including at least one hand grip for manually actuating the joint unit, ensures a simple, operator-friendly and flexible track processing. The at least one hand grip is disposed relative to the joint unit or a vertical plane defined by the joint unit, preferably on the same side as the processing assembly. Preferably, the processing assembly is disposed between the at least one hand grip and the joint unit. This provides an advantageous lever arm for manual actuation of the joint unit, in particular for swiveling the processing assembly about a horizontal swivel axis and/or a vertical swivel axis of the joint unit. Preferably, the at least one hand grip has a distance A_{H} from the horizontal swivel axis and/or vertical swivel axis, wherein: 60 cm≤A_{H}≤140 cm, in particular 70 cm≤A_{H}≤130 cm, and in particular 80 cm≤A_{H}≤120 cm. The distance A_{H} is defined in a horizontal direction, in particular in parallel with a horizontal plane defined by the chassis.

A processing machine, in which at least one first hand grip and at least one second hand grip are disposed on different sides of a plane which is defined by the joint unit, ensures a simple, operator-friendly and flexible track processing. Due to the fact that the at least one first hand grip and the at least one second hand grip are disposed on different sides of a vertical plane, the processing machine can be lifted and transported or positioned in a simple manner by two operators. Preferably, the processing machine has at least two first hand grips and/or at least two second hand grips. The vertical plane is defined in particular by a horizontal swivel axis and/or by a vertical swivel axis of the joint unit. The vertical plane runs in particular perpendicularly to a horizontal plane defined by the chassis.

A processing machine, in which the carrier includes a first carrier component and a second carrier component, which are displaceable relative to one another for adjusting the distance, ensures a simple, operator-friendly and flexible track processing. Due to the fact that the carrier includes two carrier components, which are displaceable relative to each other, it is possible to easily adjust the distance between the center of gravity of the processing assembly and the center of gravity of the counterweight. The processing assembly is attached to the first carrier component, whereas the counterweight is attached to the second carrier component. By using the adjustment mechanism, the carrier components can be displaced relative to each other so that an overall center of gravity of the processing machine can be positioned relative to the joint unit. Preferably, the carrier components are continuously displaceable relative to each other. The carrier components can, for example, be displaced linearly relative to one another and/or be swiveled relative to one another.

A processing machine, in which the adjustment mechanism includes at least one guide, ensures a simple, operator-friendly and flexible track processing. Through the use of the at least one guide, the processing assembly and the counterweight can be displaced with respect to each other in a guided manner. This allows the distance between the center of gravity of the processing assembly and the center of gravity of the counterweight to be adjusted in a simple, operator-friendly and precise manner. Preferably, the at least one guide is configured as a linear guide. The at least one guide is configured, in particular, as a telescopic guide. For example, a first carrier component and a second carrier component are displaceable relative to each other by using a guide. The carrier components are linearly displaceable relative to each other preferably by using a linear guide.

A processing machine, in which the adjustment mechanism includes at least one locking element, ensures a simple, operator-friendly and flexible track processing. Through the use of the at least one locking element, the processing machine can be locked in a transport state and/or in a working state. For transferring the processing machine from the transport state to the working state and vice versa and/or for adjusting the distance between the center of gravity of the processing assembly and the center of gravity of the counterweight, the at least one locking element is loosened. The at least one locking element, for example, is a wing screw and/or a clamping lever. The at least one locking element serves in particular to lock the at least one guide of the adjustment mechanism.

A processing machine including an energy supply unit for supplying energy to the processing assembly, ensures a simple, operator-friendly and flexible track processing. Preferably, the energy supply unit is interchangeable so that the processing machine can be operated with a desired energy supply unit according to customer requirements. In a working state, the processing assembly and the energy supply unit are disposed preferably on different sides of a vertical plane defined by the joint unit. Preferably, the processing assembly is disposed at a first carrier component, whereas the energy supply unit is disposed at a second carrier component. The energy supply unit includes, in particular, at least one accumulator and/or at least one capacitor and/or a frequency converter and/or a rectifier and/or an inverter and/or a supply connection for the connection to an energy supply network and/or an internal combustion engine generator unit. Preferably, the energy supply unit provides electrical energy.

A processing machine, in which the energy supply unit at least partially provides the counterweight, ensures a simple, operator-friendly and flexible track processing. Due to the fact that the energy supply unit provides the counterweight, a separate counterweight is not required. The energy supply unit thus serves on the one hand to supply energy to the processing assembly and on the other hand to balance the processing machine. The adjustment mechanism thus serves to adjust the distance between the center of gravity of the processing assembly and the center of gravity of the energy supply unit. Preferably, the distance is continuously adjustable. Through this, an overall center of gravity of the processing machine can be positioned relative to the joint unit and disposed in particular close to a vertical plane, preferably in the vertical plane. In this way, the processing machine can be operated and/or balanced in particular with different energy supply units that have different weights.

A processing machine, in which the energy supply unit includes at least one accumulator, ensures a simple, operator-friendly and flexible track processing. Due to the fact that the energy supply unit includes at least one accumulator, the processing machine can be operated substantially autonomously with electrical energy. Preferably, the energy supply unit includes a plurality of accumulators connected in parallel and/or in series. The at least one accumulator is preferably disposed in a replaceable manner, in particular in a replaceable manner on the carrier. Preferably, the processing assembly is disposed at a first carrier component, whereas the energy supply unit with the at least one accumulator is disposed at a second carrier component. Due to the at least one accumulator, the energy supply unit can in particular provide the counterweight. Preferably, the energy supply unit includes at least one capacitor. The at least one capacitor is connected in particular in parallel to the at least one accumulator. The at least one capacitor serves to buffer power peaks during operation and to avoid an overload of the at least one accumulator. Preferably, the energy supply unit includes a plurality of capacitors which are connected in parallel and/or in series. The energy supply unit in particular includes an accumulator arrangement including a plurality of accumulators connected in parallel and/or in series, and a capacitor arrangement including a plurality of capacitors connected in parallel and/or in series. The accumulator arrangement and the capacitor arrangement are preferably connected in parallel to one another.

A processing machine, in which the chassis includes at least two guiding rollers for sliding on the rail, ensures a simple, operator-friendly and flexible track processing. The at least two guiding rollers are preferably disposed at a distance from each other in a longitudinal rail direction so that the processing machine can be slid manually on a rail, in particular on exactly one rail, by using the chassis. The at least two guiding rollers each include an axis of rotation. The axes of rotation run in particular in parallel with one another and are spaced apart from one another in the longitudinal rail direction. The axes of rotation define, in particular, a horizontal plane. The at least two guiding rollers preferably each include at least one flange. Preferably, the at least two guiding rollers each have at least two flanges. The two flanges are disposed in particular on both sides of a roller base body so that the respective guiding roller is guided on a rail.

A processing machine including a transverse boom for the support on an adjacent rail, ensures a simple, operator-friendly and flexible track processing. The transverse boom enables a safe support on an adjacent rail. The transverse boom is detachably fastened to the carrier and/or the joint unit and/or the chassis. Preferably, the transverse boom includes at least one supporting roller for the support on the adjacent rail. Through the use of the supporting roller, the transverse boom can be manually displaced or slid on the adjacent rail.

It is further an object of the invention to create a method that enables a simple, operator-friendly and flexible track processing.

With the objects of the invention in view, there is concomitantly provided a method for track processing, comprising the steps of:
providing a processing machine according to the invention,
adjusting a distance between a center of gravity of the processing assembly and a center of gravity of the counter-weight by using the adjustment mechanism, and
performing track processing by using the processing assembly.

The advantages of the method according to the invention correspond to the advantages of the processing machine according to the invention already described. The method can be further developed in particular with at least one feature described in connection with the processing machine according to the invention.

By adjusting the distance between the center of gravity of the processing assembly and the center of gravity of the counterweight by using the adjustment mechanism, an overall center of gravity of the processing machine is positioned relative to the joint unit. Preferably, the overall center of gravity is positioned in a working state in such a way that, for a distance A_{P} from a vertical plane defined by the joint unit, 0 cm≤A_{P}≤20 cm, in particular 0 cm≤A_{P}≤10 cm, and in particular 0 cm≤A_{P}≤5 cm.

Other features which are considered as characteristic for the invention are set forth in the appended claims.

Although the invention is illustrated and described herein as embodied in a processing machine and a method for track processing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a processing machine for track processing in a working state;

FIG. 2 is a side-elevational view of the processing machine in FIG. 1;

FIG. 3 is a front-elevational view of the processing machine in FIG. 1;

FIG. 4 is a side-elevational view of the processing machine in a transport state; and

FIG. 5 is a top-perspective view onto the processing machine in FIG. 4.

### DETAILED DESCRIPTION OF THE INVENTION

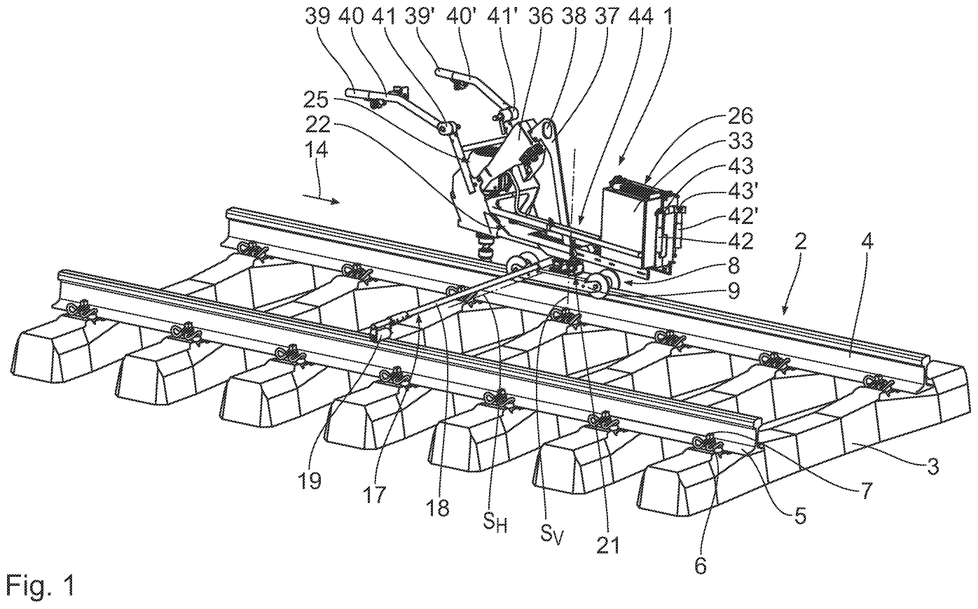

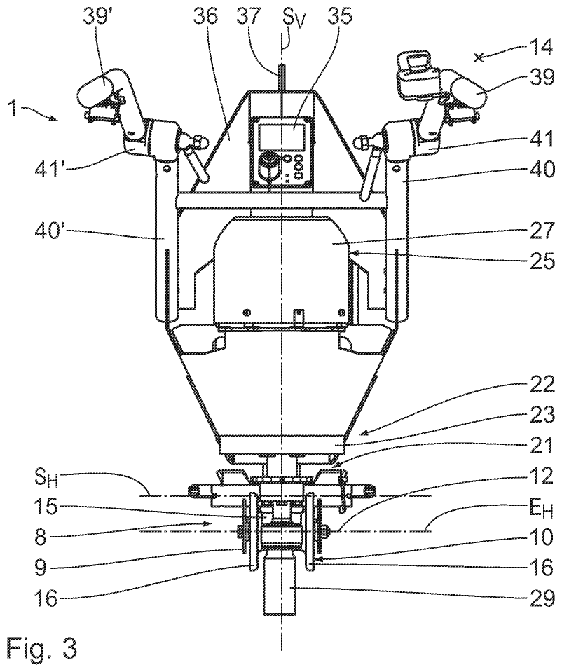

Referring now in detail to FIGS. 1 to 5 of the drawings as a whole, there is seen a processing machine 1 which serves to process a track 2. The track 2 includes sleepers 3, which are disposed in a ballast bed that is not shown. Rails 4, 5 are fastened on the sleepers 3. The rails 4, 5 are fastened by using clamping clips 6 and sleeper screws 7. The sleeper screws 7 are screwed into the sleepers 3. The processing machine 1 is configured as a screwing machine for mounting or tightening the sleeper screws 7 and/or for dismounting or loosening the sleeper screws 7.

The processing machine 1 can be displaced or slid manually on the rail 4. For this purpose, the processing machine 1 includes a chassis 8. The chassis 8 has a chassis frame 9 to which two guiding rollers 10, 11 are mounted to rotate about associated axes of rotation 12, 13. The axes of rotation 12, 13 run in parallel with one another and are mounted on the chassis frame 9 at a distance from one another in a longitudinal rail direction 14. The axes of rotation 12, 13 define a horizontal plane E_{H}.

The guiding rollers 10, 11 are configured for self-centering on the rail 4. For this purpose, the guiding rollers 10, 11 each have a roller base body 15 on which two flanges 16 are configured at the end.

The processing machine 1 includes a transverse boom 17 for support on the adjacent rail 5. The transverse boom 17 includes a transverse rod 18 on which a supporting roller 19 is rotatably mounted at the end. The transverse rod 18 is detachably fastened to the chassis frame 9 opposite to the supporting roller 19 by using a quick-release fastener 20.

The chassis 8 is fastened to a carrier 22 by using a joint unit 21. The carrier 22 includes a first carrier component 23 and a second carrier component 24. The joint unit 21 is disposed at the chassis frame 9 and the first carrier component 23. A processing assembly 25 is fastened to the first carrier component 23. An energy supply unit 26 is fastened to the second carrier component 24.

The joint unit 21 defines a horizontal swivel axis S_{H} for height adjustment of the processing assembly 25. The horizontal swivel axis S_{H} runs in parallel with the horizontal plane E_{H}. The horizontal swivel axis S_{H} defines a vertical plane E_{V} which runs perpendicularly to the horizontal plane E_{H}.

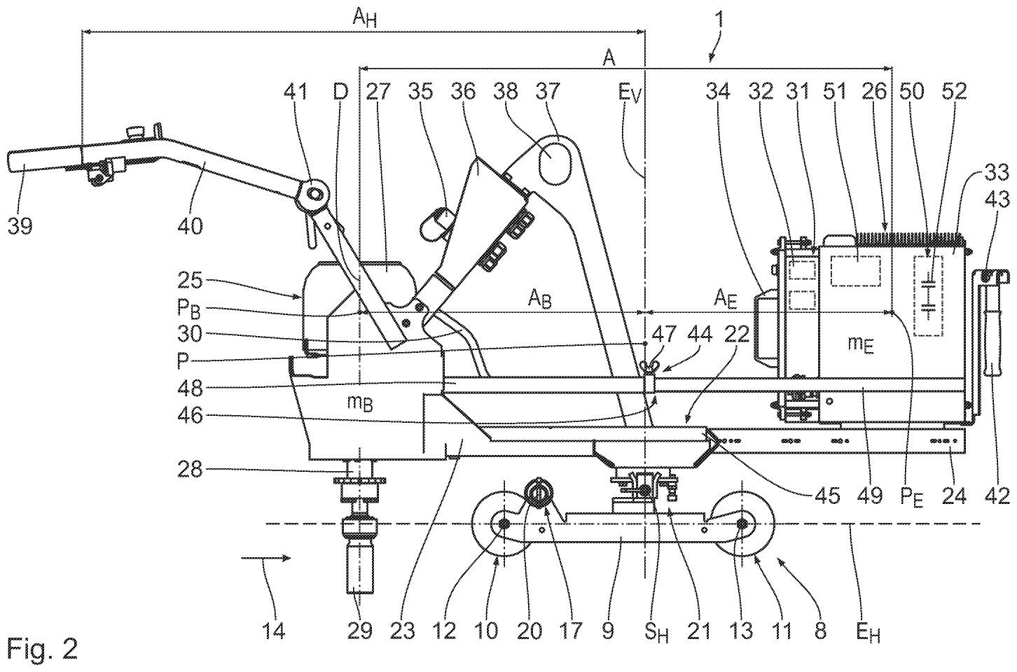

The joint unit 21 further defines a vertical swivel axis S_{V}. The vertical swivel axis S_{V} runs perpendicularly to the horizontal swivel axis S_{H}. In the swivel position of the carrier 22 about the horizontal swivel axis S_{H} shown in FIG. 2, the vertical swivel axis S_{V} runs in the vertical plane E_{V}. The vertical swivel axis S_{V} can be swiveled relative to the vertical plane E_{V} by swiveling the carrier 22 about the horizontal swivel axis S_{H}.

The carrier 22 can be swiveled relative to the chassis 8 about the horizontal swivel axis S_{H} and/or about the vertical swivel axis S_{V} by using the joint unit 21. The horizontal swivel axis S_{H} serves to adjust the height of the processing assembly 25. The vertical swivel axis S_{V} serves to position the processing assembly 25 on two sides of the rail 4. This allows the sleeper screws 7 to be mounted or dismounted on both sides of the rail 4 on which the processing machine 1 is disposed by using the chassis 8.

The processing assembly 25 includes an electric drive motor 27, which drives a drive shaft 28 in rotation about an axis of rotation D. A processing tool 29 is fastened to the drive shaft 28 in an interchangeable manner. The processing tool 29, for example, is a screw nut for actuating the sleeper screws 7.

The processing assembly 25 is supplied with electrical energy by the energy supply unit 26. For this purpose, the processing assembly 25 is connected to the energy supply unit 26 through a line connection 30. The energy supply unit 26 includes an accumulator arrangement 31 with a plurality of accumulators 32 which are connected in series and/or in parallel. Furthermore, the energy supply unit 26 includes a housing 33 in which a capacitor arrangement 50 and a motor controller 51 for controlling and supplying power to the drive motor 27 are disposed. The capacitor arrangement 50 includes a plurality of capacitors 52 connected in series and/or in parallel. The capacitor arrangement 50 is connected in parallel to the accumulator arrangement 31 and serves to buffer power peaks during operation and to prevent an overload of the accumulator arrangement 31.

The accumulator arrangement 31 is interchangeably fastened to the second carrier component 24. The accumulator arrangement 31 includes a hand grip 34 for replacement.

In order to control the processing assembly 25, the processing machine 1 includes a control unit 35. The control unit 35 is fastened to a protective element 36. The protective element 36 is connected to the first carrier component 23 on both sides of the processing assembly 25. The protective element 36 is supported on and connected to the first carrier component 23 in the region of the joint unit 21 through a supporting element 37. The supporting element 37 includes a fastening eye 38. In order to control the processing assembly 25, the control unit 35 is in signal connection with the energy supply unit 26 and in particular with the motor control 51.

The processing machine 1 includes two first hand grips 39, 39′ for the manual actuation of the joint unit 21. The hand grips 39, 39′ are connected to the first carrier component 23 through a respective rod assembly 40, 40′. For the height adjustment of the hand grips 39, 39′, the respective rod assembly 40, 40′ includes a swivel joint 41, 41′. The hand grips 39, 39′ have a minimum distance A_{H} from the vertical plane E_{V}, parallel to the horizontal plane E_{H}, wherein the following applies to the distance A_{H}: 60 cm≤A_{H}≤140 cm, in particular 70 cm≤A_{H}≤130 cm, and in particular 80 cm≤A_{H}≤120 cm.

Two second hand grips 42, 42′ are fastened to the second carrier component 24. The second hand grips 42, 42′ are disposed at the second carrier component 24 through a respective swivel joint 43, 43′. The first hand grips 39, 39′ and the second hand grips 42, 42′ are disposed on different sides of the vertical plane E_{V}. This allows the processing machine 1 to be lifted in a simple manner by two operators.

The processing assembly 25 has a first center of gravity P_{B} and a first mass m_{B}. The first center of gravity P_{B} has a first distance A_{B} from the vertical plane E_{V}, when viewed in parallel with the horizontal plane E_{H} and perpendicularly to the vertical plane E_{V}. Further, the energy supply unit 26 has a second center of gravity P_{E} and a second mass m_{E}. The second center of gravity P_{E} has a second distance A_{E} from the vertical plane E_{V}, when viewed in parallel with the horizontal plane E_{H} and perpendicularly to the vertical plane E_{V}.

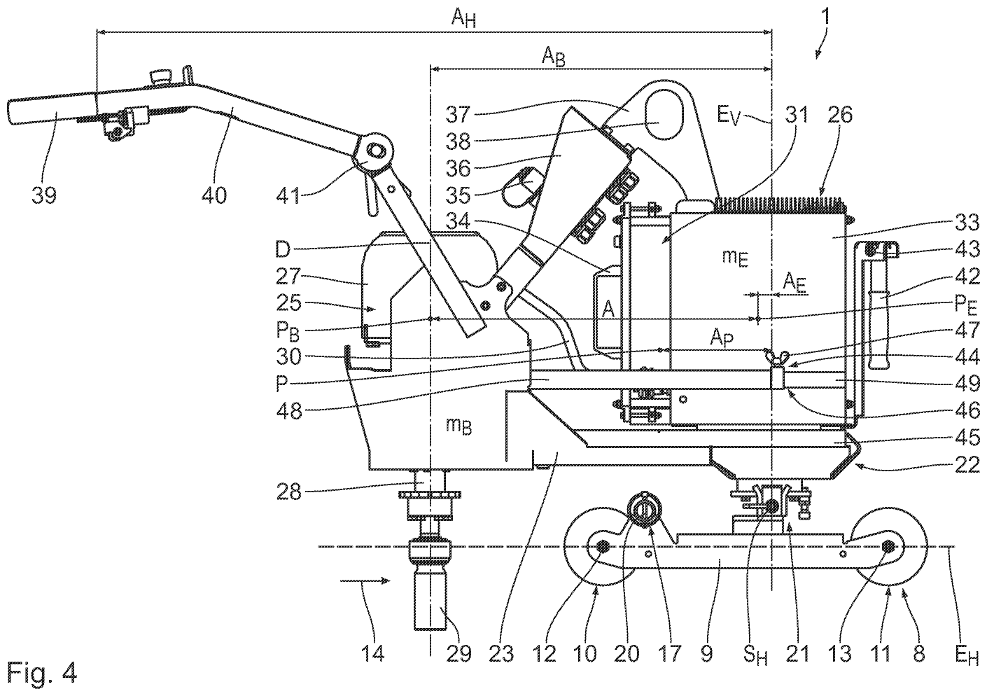

The processing assembly 25 and the energy supply unit 26 are disposed on different sides of the vertical plane E_{V} in the working state shown in FIG. 2. The energy supply unit 26 forms a counterweight to the processing assembly 25 relative to the joint unit 21, in particular relative to the horizontal swivel axis S_{H}. For balancing the processing machine 1 relative to the joint unit 21, in particular relative to the horizontal swivel axis S_{H}, the processing machine 1 includes an adjustment mechanism 44. The adjustment mechanism 44 serves to adjust a distance A of the centers of gravity P_{B} and P_{E} to one another. By adjusting the distance A, an overall center of gravity P of the processing machine 1 is positioned relative to the joint unit 21, in particular relative to the vertical plane E_{V}. Depending on the position, the overall center of gravity P—viewed in parallel with the horizontal plane E_{H} and perpendicularly to the vertical plane E_{V}—has a distance A_{P} from the vertical plane E_{V} which can be adjusted. In the working state shown in FIG. 2, the overall center of gravity P is positioned in the vertical plane E_{V} so that A_{P}=0 cm. In contrast, the overall center of gravity P is positioned outside the vertical plane E_{V} in the transport state shown in FIG. 4 so that A_{P}>0 cm.

The adjustment mechanism 44 includes a first linear guide 45, a second linear guide 46, and a locking element 47. The first linear guide 45 is configured between the first carrier component 23 and the second carrier component 24. The second carrier component 24 is telescopically displaceable in a linear manner within the first carrier component 23. The second linear guide 46 is configured as a telescoping rod and includes a first telescoping tube 48 and a second telescoping tube 49, which is linearly guided within the first telescoping tube 48. The first telescoping tube 48 is fastened to the first carrier component 23, whereas the second telescoping tube 49 is detachably fastened to the inverter 33 of the energy supply unit 26. The telescoping rod is part of the carrier 22. Through the use of the locking element 47, the telescoping tubes 48, 49 can be locked relative to one another. Through the use of the adjustment mechanism 44, the second distance A_{E} is adjustable, whereas the first distance A_{B} is not adjustable. The following applies: A=A_{B}+A_{E} so that the distance A can be adjusted by adjusting the distance A_{E}.

The mode of operation of the processing machine 1 is described hereinafter:

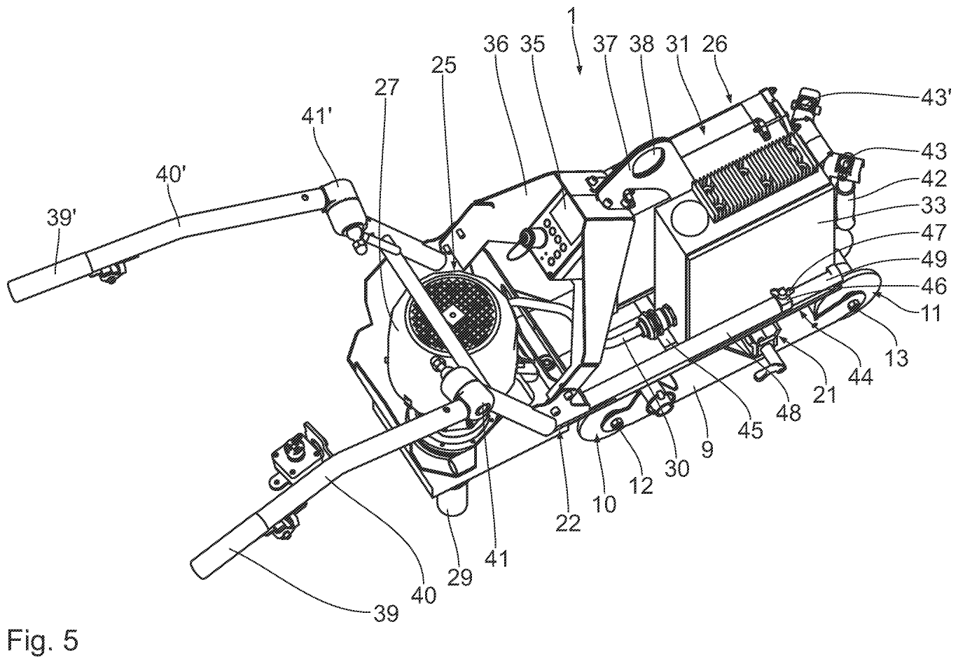

In the transport state shown in FIGS. 4 and 5, the energy supply unit 26 is displaced by using the adjustment mechanism 44 in such a way that the centers of gravity P_{B} and P_{E} are located on a mutual side of the vertical plane E_{V}. The distance A_{E} is thus negative so that the distance A between the centers of gravity P_{B} and P_{E} is minimal. The overall center of gravity P of the processing machine 1 in the transport state—viewed in parallel with the vertical plane E_{V}—is positioned below the fastening eye 38. Thus, for the distance A_{P} from the vertical plane E_{V}: A_{P}>0 cm. The distance A_{P} is in particular at a maximum. In the transport state, the processing machine 1 is compact and can be easily transported by two operators by using the hand grips 39, 39′ and 42, 42′. Furthermore, the processing machine 1 can be lifted by a lifting device not shown in more detail by fastening the lifting device in the fastening eye 38. Due to the fact that the overall center of gravity P is located below the fastening eye 38, the processing machine 1 is balanced in the transport state. In the transport state, the transverse boom 17 is dismounted by using the quick-release fastener 20.

When the processing machine 1 with the chassis 8 is on the rail 4, the processing machine 1 is transferred from the transport state to the working state. For this purpose, the transverse boom 17 is mounted on the chassis 8 by using the quick-release fastener 20 so that the processing machine 1 is supported on the adjacent rail 5.

The locking element 47 is loosened and the energy supply unit 26 is displaced by using the linear guides 45, 46 in such a way that the centers of gravity P_{B} and P_{E} are located on different sides of the vertical plane E_{V}. The energy supply unit 26 thus acts relative to the joint unit 21 as a counterweight to the processing assembly 25. The distance A between the centers of gravity P_{B} and P_{E} is adjusted by using the linear guides 45, 46 in such a way that the overall center of gravity P is located as close as possible to the vertical plane E_{V}, preferably positioned in the vertical plane E_{V}. This balances the processing machine 1 relative to the joint unit 21, in particular to the horizontal swivel axis S_{H}. Subsequently, the adjusted distance A in which the telescoping tubes 48, 49 are fixed to each other is fixed by using the locking element 47. The working state is illustrated in FIGS. 1 and 2.

Due to the fact that the processing machine 1 is balanced relative to the joint unit 21, the processing of the track 2, i.e. the mounting and/or dismounting of the sleeper screws 7, is possible in a simple and operator-friendly manner by using the processing assembly 25. The processing tool 29 can be adjusted in height and/or positioned on different sides of the rail 4 in a simple manner by an operator by manually swiveling the processing assembly 25 about the horizontal swivel axis S_{H} and/or about the vertical swivel axis S_{V}. Only a minimum amount of force is required from the operator for swiveling.

1. A processing machine for track processing, the processing machine comprising:
a carrier;
a chassis disposed on said carrier for manually sliding the processing machine on a rail of a track;
a joint unit for swiveling said carrier relative to said chassis;
a processing assembly disposed on said carrier for processing the track;
a counterweight to said processing assembly, said counterweight disposed at said carrier; and
an adjustment mechanism for adjusting a distance between a center of gravity of said processing assembly and a center of gravity of said counterweight.

2. The processing machine according to claim 1, wherein said joint unit defines a horizontal swivel axis for a height adjustment of said processing assembly.

3. The processing machine according to claim 1, wherein said joint unit defines a vertical swivel axis for positioning said processing assembly on two sides of a rail.

4. The processing machine according to claim 1, wherein said processing assembly and said counterweight are disposed on different sides of a plane defined by said joint unit.

5. The processing machine according to claim 1, which further comprises at least one hand grip for manually actuating said joint unit.

6. The processing machine according to claim 1, which further comprises at least one first hand grip and at least one second hand grip disposed on different sides of a plane defined by said joint unit.

7. The processing machine according to claim 1, wherein said carrier includes a first carrier component and a second carrier component being displaceable relative to one another for adjusting the distance.

8. The processing machine according to claim 1, wherein said adjustment mechanism includes at least one guide.

9. The processing machine according to claim 1, wherein said adjustment mechanism includes at least one locking element.

10. The processing machine according to claim 1, which further comprises an energy supply unit for supplying energy to said processing assembly.

11. The processing machine according to claim 10, wherein said energy supply unit at least partially provides said counterweight.

12. The processing machine according to claim 10, wherein said energy supply unit includes at least one accumulator.

13. The processing machine according to claim 1, wherein said chassis includes at least two guiding rollers for sliding on the rail.

14. The processing machine according to claim 1, which further comprises a transverse boom for supporting the processing machine on a rail adjacent the rail of the track.

15. A method for track processing, the method comprising:
providing a processing machine for track processing, the processing machine including:
a carrier,
a chassis disposed on the carrier for manually sliding the processing machine on a rail of a track,
a joint unit for swiveling the carrier relative to the chassis,
a processing assembly disposed on the carrier for processing the track,
a counterweight to the processing assembly, the counterweight disposed at the carrier, and
an adjustment mechanism for adjusting a distance between a center of gravity of the processing assembly and a center of gravity of the counterweight;
using the adjustment mechanism for adjusting a distance between the center of gravity of the processing assembly and the center of gravity of the counterweight; and
using the processing assembly to perform track processing.
